(19) United States
(12) Patent Application Publication
(10) Pub. No.: US 2024/0095879 A1
(43) Pub. Date: Mar. 21, 2024

(54) Image Generation with Resolution Constraints

(71) Applicant: Apple Inc., Cupertino, CA (US)

(72) Inventors: Andreas Gapel, Redwood City, CA (US); Nitin Nandakumar, Sunnyvale, CA (US); Sabine Webel, San Francisco, CA (US); Tobias Eble, Laupheim (DE)

(21) Appl. No.: 18/369,638

(22) Filed: Sep. 18, 2023

Related U.S. Application Data
(60) Provisional application No. 63/408,272, filed on Sep. 20, 2022.

(51) Int. Cl. G06T 3/40; G06F 3/01; G06T 11/00

(52) U.S. Cl. CPC G06T 3/40; G06F 3/013; G06T 11/00; G06T 2200/16; G06T 2210/08

(57) ABSTRACT

In one implementation, a method of generating an image is performed by a device including one or more processors and non-transitory memory. The method includes generating a first resolution function based on a formula with a set of variables having a first set of values. The method includes generating a first image based on first content and the first resolution function. The method includes detecting a resolution constraint. The method includes generating a second resolution function based on the formula with the set of variables having a second set of values, wherein the second resolution function has a summation value that satisfies the resolution constraint. The method includes generating a second image based on second content and the second resolution function.

### CROSS-REFERENCE TO RELATED APPLICATIONS

This application claims priority to U.S. Provisional Patent App. No. 63/408,272, filed on Sep. 20, 2022, which is hereby incorporated by reference in its entirety.

### TECHNICAL FIELD

The present disclosure generally relates to image generation, and in particular, to systems, methods, and devices for generating images with a varying amount of detail.

### BACKGROUND

Rendering or otherwise processing an image can be computationally expensive. Accordingly, to reduce this computational burden, advantage is taken of the fact that humans typically have relatively weak peripheral vision. Accordingly, different portions of the image are presented on a display panel with different resolutions. For example, in various implementations, portions corresponding to a user's fovea are presented with higher resolution than portions corresponding to a user's periphery.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 illustrates an XR pipeline that receives XR content and displays an image on a display panel based on the XR content in accordance with some implementations.

FIGS. 3A-3D illustrate various resolution functions in a first dimension in accordance with various implementations.

FIGS. 4A-4D illustrate various two-dimensional resolution functions in accordance with various implementations.

FIG. 5A illustrates an example resolution function that characterizes a resolution in a display space as a function of angle in a warped space in accordance with some implementations.

FIG. 5B illustrates the integral of the example resolution function of FIG. 5A in accordance with some implementations.

FIG. 5C illustrates the tangent of the inverse of the integral of the example resolution function of FIG. 5A in accordance with some implementations.

FIG. 6A illustrates an example resolution function for performing static foveation in accordance with some implementations.

FIG. 6B illustrates an example resolution function for performing dynamic foveation in accordance with some implementations.

FIG. 7 is a flowchart representation of a method of rendering an image based on a resolution function in accordance with some implementations.

FIG. 8A illustrates an example image representation, in a display space, of XR content to be rendered in accordance with some implementations.

FIG. 8B illustrates a warped image of the XR content of FIG. 8A in accordance with some implementations.

FIG. 9 is a flowchart representation of a method of rendering an image in one of a plurality of foveation modes in accordance with some implementations.

FIG. 10 is a flowchart representation of a method of rendering an image based on eye tracking metadata in accordance with some implementations.

FIGS. 11A-11B illustrate various confidence-based resolution functions in accordance with various implementations.

FIG. 12 is a flowchart representation of a method of generating an image based on a resolution constraint in accordance with various implementations.

FIGS. 13A-13F illustrate resolution functions having various summation values in accordance with various implementations.

FIGS. 14A-14C illustrate various constrained resolution functions in accordance with various implementations.

FIG. 15 is a flowchart representation of a method of rendering an image with a constrained resolution function in accordance with some implementations.

FIG. 16 is a block diagram of an example controller in accordance with some implementations.

FIG. 17 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and method for generating an image. In various implementations, the method is performed by a device including one or more processors and non-transitory memory. The method includes generating a first resolution function based on a formula with a set of variables having a first set of values. The method includes generating a first image based on first content and the first resolution function. The method includes detecting a resolution constraint. The method includes generating a second resolution function based on the formula with the set of variables having a second set of values, wherein the second resolution function has a summation value that satisfies the resolution constraint. The method includes generating a second image based on second content and the second resolution function.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, different portions of an image are presented on a display panel with different resolutions. Various methods of determining the resolution for different portions of an image based on a number of factors are described below.

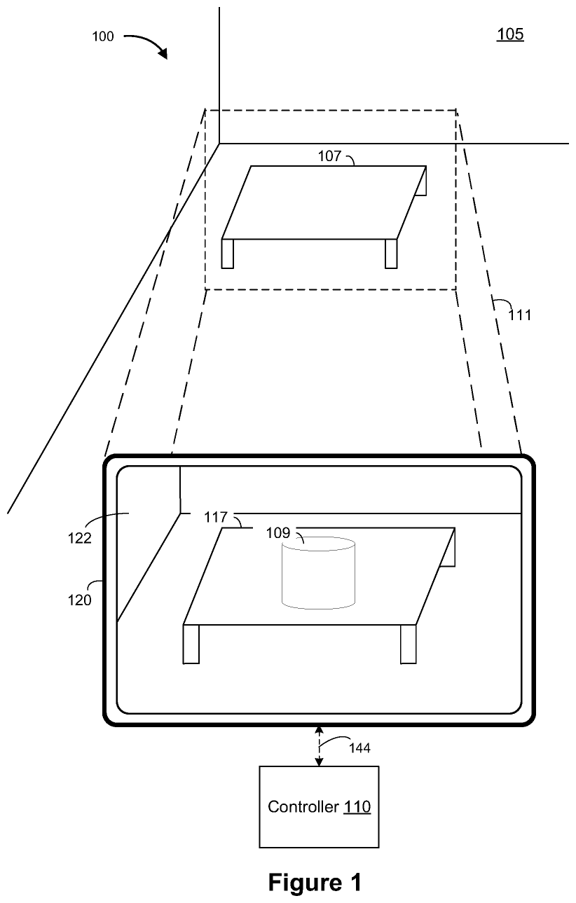

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

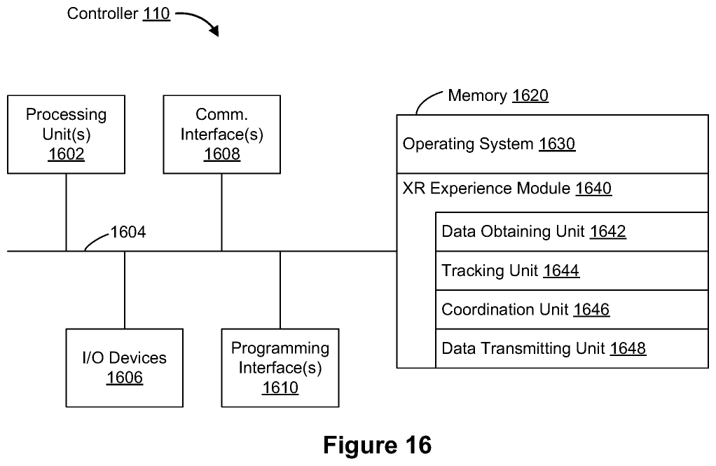

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 16. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

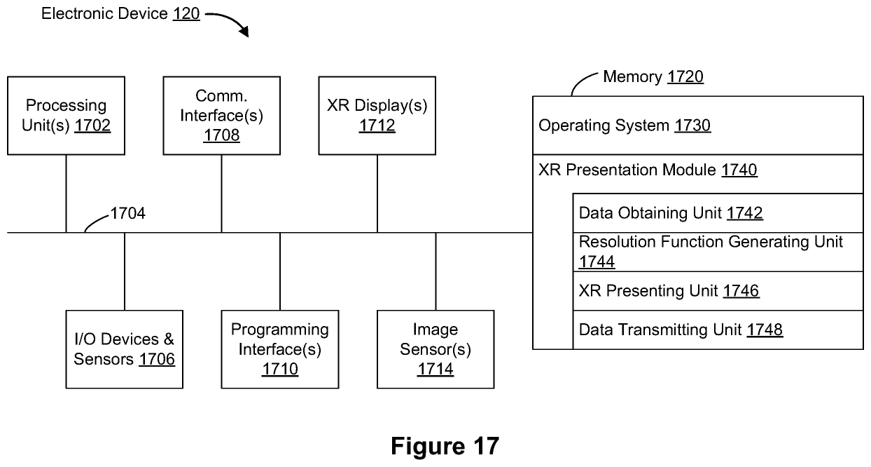

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 17.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

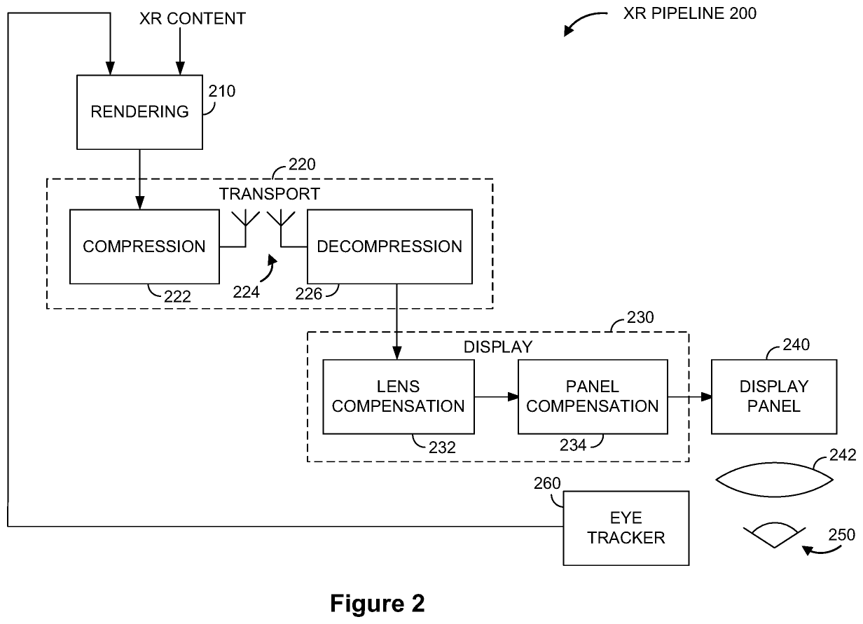

In various implementations, the electronic device 120 includes an XR pipeline that presents the XR content. FIG. 2 illustrates an XR pipeline 200 that receives XR content and displays an image on a display panel 240 based on the XR content.

The XR pipeline 200 includes a rendering module 210 that receives the XR content (and eye tracking data from an eye tracker 260) and renders an image based on the XR content. In various implementations, XR content includes definitions of geometric shapes of virtual objects, colors and/or textures of virtual objects, images (such as a pass-through image of the physical environment), and other information describing content to be represented in the rendered image.

An image includes a matrix of pixels, each pixel having a corresponding pixel value and a corresponding pixel location. In various implementations, the pixel values range from 0 to 255. In various implementations, each pixel value is a color triplet including three values corresponding to three color channels. For example, in one implementation, an image is an RGB image and each pixel value includes a red value, a green value, and a blue value. As another example, in one implementation, an image is a YUV image and each pixel value includes a luminance value and two chroma values. In various implementations, the image is a YUV444 image in which each chroma value is associated with one pixel. In various implementations, the image is a YUV420 image in which each chroma value is associated with a 2×2 block of pixels (e.g., the chroma values are downsampled). In some implementations, an image includes a matrix of tiles, each tile having a corresponding tile location and including a block of pixels with corresponding pixel values. In some implementations, each tile is a 32×32 block of pixels. While specific pixel values, image formats, and tile sizes are provided, it should be appreciated that other values, formats, and tile sizes may be used.

The image rendered by the rendering module 210 (e.g., the rendered image) is provided to a transport module 220 that couples the rendering module 210 to a display module 230. The transport module 220 includes a compression module 222 that compresses the rendered image (resulting in a compressed image), a communications channel 224 that carries the compressed image, and a decompression module 226 that decompresses the compressed image (resulting in a decompressed image).

The decompressed image is provided to a display module 230 that converts the decompressed image into panel data. The panel data is provided to a display panel 240 that displays a displayed image as described by (e.g., according to) the panel data. The display module 230 includes a lens compensation module 232 that compensates for distortion caused by an eyepiece 242 of the electronic device 120. For example, in various implementations, the lens compensation module 232 pre-distorts the decompressed image in an inverse relationship to the distortion caused by the eyepiece 242 such that the displayed image, when viewed through the eyepiece 242 by a user 250, appears undistorted. The display module 230 also includes a panel compensation module 234 that converts image data into panel data to be read by the display panel 240.

The eyepiece 242 limits the resolution that can be perceived by the user 250. In various implementations, the maximum resolution that the eyepiece 242 can support is expressed as an eyepiece resolution function that varies as a function of distance from an origin of the display space. In various implementations, the maximum resolution that the eyepiece 242 can support is expressed as an eyepiece resolution function that varies as a function of an angle between the optical axis of the user 250 and the optical axis when the user 250 is looking at the center of the eyepiece 242. In various implementations, the maximum resolution that the eyepiece 242 can support is expressed as an eyepiece resolution function that varies as a function an angle between the optical axis of the user 250 and the optical axis when the user 250 is looking at the center of the display panel 240.

The display panel 240 includes a matrix of M×N pixels located at respective locations in a display space. The display panel 240 displays the displayed image by emitting light from each of the pixels as described by (e.g., according to) the panel data.

In various implementations, the XR pipeline 200 includes an eye tracker 260 that generates eye tracking data indicative of a gaze of the user 250. In various implementations, the eye tracking data includes data indicative of a fixation point of the user 250 on the display panel 240. In various implementations, the eye tracking data includes data indicative of a gaze angle of the user 250, such as the angle between the current optical axis of the user 250 and the optical axis when the user 250 is looking at the center of the display panel 240.

In various implementations, in order to render an image for display on the display panel 240, the rendering module 210 generates M×N pixel values for each pixel of an M×N image. Thus, each pixel of the rendered image corresponds to a pixel of the display panel 240 with a corresponding location in the display space. Thus, the rendering module 210 generates a pixel value for M×N pixel locations uniformly spaced in a grid pattern in the display space.

Rendering M×N pixel values can be computationally expensive. Further, as the size of the rendered image increases, so does the amount of processing needed to compress the image at the compression module 222, the amount of bandwidth needed to transport the compressed image across the communications channel 224, and the amount of processing needed to decompress the compressed image at the decompression module 226.

In various implementations, in order to decrease the size of the rendered image without degrading the user experience, foveation (e.g., foveated imaging) is used. Foveation is a digital image processing technique in which the image resolution, or amount of detail, varies across an image. Thus, a foveated image has different resolutions at different parts of the image. Humans typically have relatively weak peripheral vision. According to one model, resolvable resolution for a user is maximum over a fovea (e.g., an area where the user is gazing) and falls off in an inverse linear fashion. Accordingly, in one implementation, the displayed image displayed by the display panel 240 is a foveated image having a maximum resolution at a fovea and a resolution that decreases in an inverse linear fashion in proportion to the distance from the fovea.

Because some portions of the image have a lower resolution, an M×N foveated image includes less information than an M×N unfoveated image. Thus, in various implementations, the rendering module 210 generates, as a rendered image, a foveated image. The rendering module 210 can generate an M×N foveated image more quickly and with less processing power (and battery power) than the rendering module 210 can generate an M×N unfoveated image. Also, an M×N foveated image can be expressed with less data than an M×N unfoveated image. In other words, an M×N foveated image file is smaller in size than an M×N unfoveated image file. In various implementations, compressing an M×N foveated image using various compression techniques results in fewer bits than compressing an M×N unfoveated image.

A foveation ratio, R, can be defined as the amount of information in the M×N unfoveated image divided by the amount of information in the M×N foveated image. In various implementations, the foveation ratio is between 1.5 and 10. For example, in some implementations, the foveation ratio is 2. In some implementations, the foveation ratio is 3 or 4. In some implementations, the foveation ratio is constant among images. In some implementations, the foveation ratio is determined for the image being rendered. For example, in various implementations, the amount of information the XR pipeline 200 is able to throughput within a particular time period, e.g., a frame period of the image, may be limited. For example, in various implementations, the amount of information the rendering module 210 is able to render in a frame period may decrease due to a thermal event (e.g., when processing to compute additional pixel values would cause a processor to overheat). As another example, in various implementations, the amount of information the transport module 220 is able to transport in a frame period may decrease due to a decrease in the signal-to-noise ratio of the communications channel 224.

In some implementations, in order to render an image for display on the display panel 240, the rendering module 210 generates M/R×N/R pixel values for each pixel of an M/R×N/R warped image. Each pixel of the warped image corresponds to an area greater than a pixel of the display panel 240 at a corresponding location in the display space. Thus, the rendering module 210 generates a pixel value for each of M/R×N/R locations in the display space that are not uniformly distributed in a grid pattern. The respective area in the display space corresponding to each pixel value is defined by the corresponding location in the display space (a rendering location) and a scaling factor (or a set of a horizontal scaling factor and a vertical scaling factor).

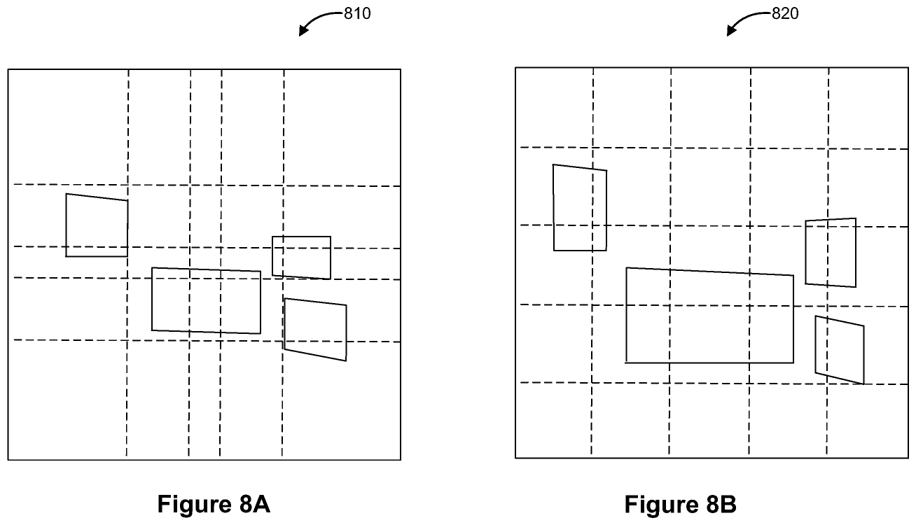

In various implementations, the rendering module 210 generates, as a rendered image, a warped image. In various implementations, the warped image includes a matrix of M/R×N/R pixel values for M/R×N/R locations uniformly spaced in a grid pattern in a warped space that is different than the display space. Particularly, the warped image includes a matrix of M/R×N/R pixel values for M/R×N/R locations in the display space that are not uniformly distributed in a grid pattern. Thus, whereas the resolution of the warped image is uniform in the warped space, the resolution varies in the display space. This is described in greater detail below with respect to FIGS. 8A and 8B.

The rendering module 210 determines the rendering locations and the corresponding scaling factors based on a resolution function that generally characterizes the resolution of the rendered image in the displayed space.

In one implementation, the resolution function, S(x), is a function of a distance from an origin of the display space (which may correspond to the center of the display panel 240). In another implementation, the resolution function, S(θ), is a function of an angle between an optical axis of the user 250 and the optical axis when the user 250 is looking at the center of the display panel 240. Thus, in one implementation, the resolution function, S(θ), is expressed in pixels per degree (PPD).

Humans typically have relatively weak peripheral vision. According to one model, resolvable resolution for a user is maximum over a fovea and falls off in an inverse linear fashion as the angle increases from the optical axis. Accordingly, in one implementation, the resolution function (in a first dimension) is defined as:

$$S ( θ ) = \{ \begin{matrix}{S}_{max} & for \vert θ \vert < {θ}_{f} \\ {S}_{min} + \frac{{S}_{max} - {S}_{min}}{1 + w ( \vert θ - {θ}_{f} \vert )} & for \vert θ \vert \geq {θ}_{f}\end{matrix} ,$$

where Sₘₐₓ is the maximum of the resolution function (e.g., approximately 60 PPD), Sₘᵢₙ is the asymptote of the resolution function, Of characterizes the size of the fovea, and w characterizes a width of the resolution function or how quickly the resolution function falls off outside the fovea as the angle increases from the optical axis.

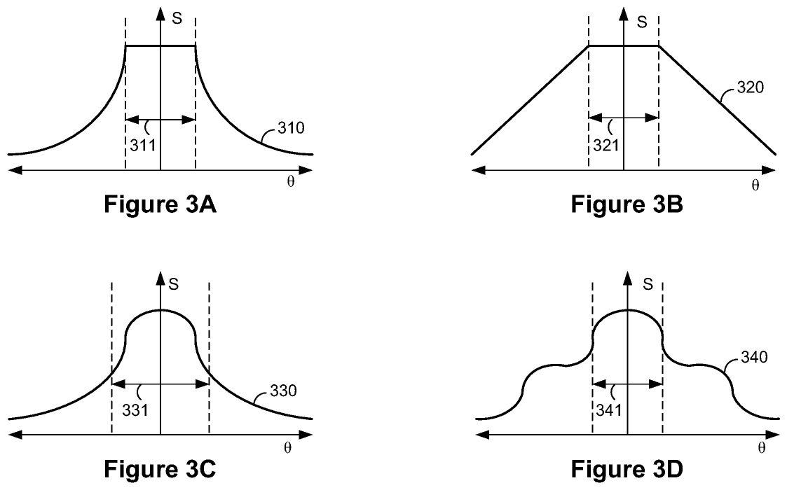

FIG. 3A illustrates a resolution function 310 (in a first dimension) which falls off in an inverse linear fashion from a fovea. FIG. 3B illustrates a resolution function 320 (in a first dimension) which falls off in a linear fashion from a fovea. FIG. 3C illustrates a resolution function 330 (in a first dimension) which is approximately Gaussian. FIG. 3D illustrates a resolution function 340 (in a first dimension) which falls off in a rounded stepwise fashion.

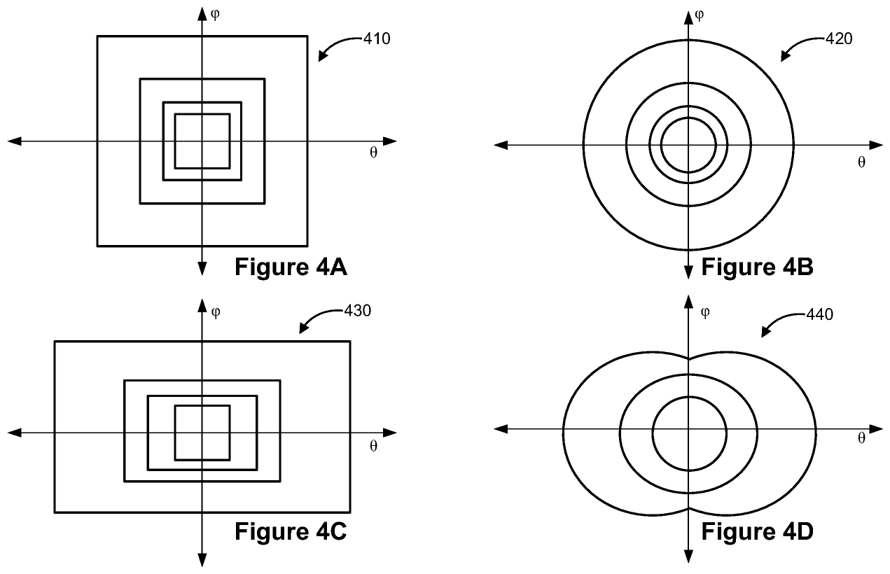

Each of the resolutions functions 310-340 of FIGS. 3A-3D is in the form of a peak including a peak height (e.g., a maximum value) and a peak width. The peak width can be defined in a number of ways. In one implementation, the peak width is defined as the size of the fovea (as illustrated by width 311 of FIG. 3A and width 321 of FIG. 3B). In one implementation, the peak width is defined as the full width at half maximum (as illustrated by width 331 of FIG. 3C). In one implementation, the peak width is defined as the distance between the two inflection points nearest the origin (as illustrated by width 341 of FIG. 3D).

Whereas FIGS. 3A-3D illustrate resolution functions in a single dimension, it is to be appreciated that the resolution function used by the rendering module 210 can be a two-dimensional function. FIG. 4A illustrates a two-dimensional resolution function 410 in which the resolution function 410 is independent in a horizontal dimension (θ) and a vertical dimension (φ). FIG. 4B illustrates a two-dimensional resolution function 420 in which the resolution function 420 a function of single variable (e.g., D=\sqrt{θ²+φ²}). FIG. 4C illustrates a two-dimensional resolution function 430 in which the resolution function 430 is different in a horizontal dimension (θ) and a vertical dimension (φ). FIG. 4D illustrates a two-dimensional resolution function 440 based on a human vision model.

As described in detail below, the rendering module 210 generates the resolution function based on a number of factors, including biological information regarding human vision, eye tracking data, eye tracking metadata, the XR content, and various constraints (such as constraints imposed by the hardware of the electronic device 120).

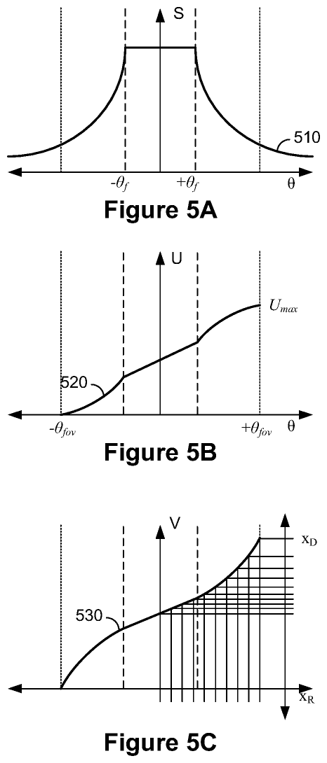

FIG. 5A illustrates an example resolution function 510, denoted S(θ), which characterizes a resolution in the display space as a function of angle in the warped space. The resolution function 510 is a constant (e.g., Sₘₐₓ) within a fovea (between −θ_{f} and +θ_{f}) and falls off in an inverse linear fashion outside this window.

FIG. 5B illustrates the integral 520, denoted U(θ), of the resolution function 510 of FIG. 5A within a field-of-view, e.g., from −θ_{fov} to +θ_{fov}. Thus, U(θ)=∫_{-θ}_{_{fov}}^{θ}S(\check{θ})d\check{θ}. The integral 520 ranges from 0 at −θ_{fov} to a maximum value, denoted Uₘₐₓ, at +θ_{fov}.

FIG. 5C illustrates the tangent 530, denoted V(x_{R}), of the inverse of the integral 520 of the resolution function 510 of FIG. 5A. Thus, V(x_{R})=tan (U⁻¹(x_{R})). The tangent 530 illustrates a direct mapping from rendered space, in x_{R}, to display space, in x_{D}. According to the foveation indicated by the resolution function 510, the uniform sampling points in the warped space (equally spaced along the x_{R} axis) correspond to non-uniform sampling points in the display space (non-equally spaced along the x_{D} axis). Scaling factors can be determined by the distances between the non-uniform sampling points in the display space.

When performing static foveation, the rendering module 210 uses a resolution function that does not depend on the gaze on the user. However, when performing dynamic foveation, the rendering module 210 uses a resolution function that depends on the gaze of the user. In particular, when performing dynamic foveation, the rendering module 210 uses a resolution function that has a peak height at a location corresponding to a location in the display space at which the user is looking (e.g., a gaze point of the user as determined by the eye tracker 260).

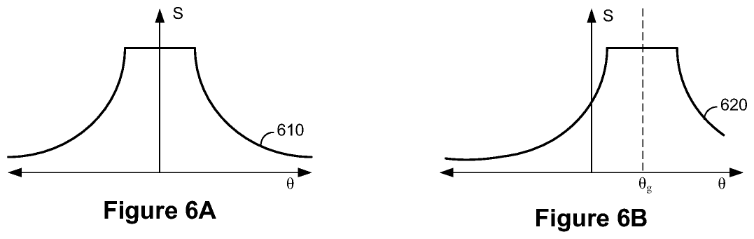

FIG. 6A illustrates a resolution function 610 that may be used by the rendering module 210 when performing static foveation. The rendering module 210 may also use the resolution function 610 of FIG. 6A when performing dynamic foveation and the user is looking at the center of the display panel 240. FIG. 6B illustrates a resolution function 620 that may be used by the rendering module 210 when performing dynamic foveation and the user is looking at a gaze angle (θ_{g}) away from the center of the display panel 240.

Accordingly, in one implementation, the resolution function (in a first dimension) is defined as:

$$S ( θ ) = \{ \begin{matrix}{S}_{max} & for \vert θ - {θ}_{ℊ} \vert < {θ}_{f} \\ {S}_{min} + \frac{{S}_{max} - {S}_{min}}{1 + w ( \vert θ - {θ}_{ℊ} - {θ}_{f} \vert )} & for \vert θ - {θ}_{ℊ} \vert \geq {θ}_{f}\end{matrix} .$$

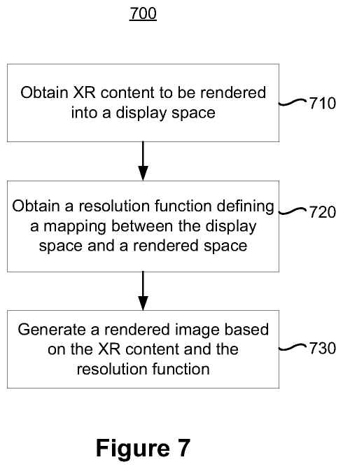

FIG. 7 is a flowchart representation of a method 700 of rendering an image in accordance with some implementations. In some implementations (and as detailed below as an example), the method 700 is performed by a rendering module, such as the rendering module 210 of FIG. 2. In various implementations, the method 700 is performed by an electronic device, such as the electronic device 120 of FIG. 1, or a portion thereof, such as the XR pipeline 200 of FIG. 2. In various implementations, the method 700 is performed by a device with one or more processors, non-transitory memory, and one or more XR displays. In some implementations, the method 700 is performed by processing logic, including hardware, firmware, software, or a combination thereof. In some implementations, the method 700 is performed by a processor executing instructions (e.g., code) stored in a non-transitory computer-readable medium (e.g., a memory).

The method 700 begins, at block 710, with the rendering module obtaining XR content to be rendered into a display space. In various implementations, XR content can include definitions of geometric shapes of virtual objects, colors and/or textures of virtual objects, images (such as a pass-through image of the physical environment), or other information describing content to be represented in the rendered image.

The method 700 continues, at block 720, with the rendering module obtaining a resolution function defining a mapping between the display space and a warped space. Various resolution functions are illustrated in FIGS. 3A-3D and FIGS. 4A-4D. Various methods of generating a resolution function are described further below.

In various implementations, the resolution function generally characterizes the resolution of the rendered image in the display space. Thus, the integral of the resolution function provides a mapping between the display space and the warped space (as illustrated in FIGS. 5A-5C). In one implementation, the resolution function, S(x), is a function of a distance from an origin of the display space. In another implementation, the resolution function, S(θ), is a function of an angle between an optical axis of the user and the optical axis when the user is looking at the center of the display panel. Accordingly, the resolution function characterizes a resolution in the display space as a function of angle (in the display space). Thus, in one implementation, the resolution function, S(θ), is expressed in pixels per degree (PPD).

In various implementations, the rendering module performs dynamic foveation and the resolution function depends on the gaze of the user. Accordingly, in some implementations, obtaining the resolution function includes obtaining eye tracking data indicative of a gaze of a user, e.g., from the eye tracker 260 of FIG. 2, and generating the resolution function based on the eye tracking data. In various implementations, the eye tracking data includes at least one of a data indicative of a gaze angle of the user or data indicative of a gaze point of the user. In particular, in various implementations, generating the resolution function based on the eye tracking data includes generating a resolution function having a peak height at a location the user is looking at as indicated by the eye tracking data.

The method 700 continues, at block 730, with the rendering module generating a rendered image based on the XR content and the resolution function. The rendered image includes a warped image with a plurality of pixels at respective locations uniformly spaced in a grid pattern in the warped space. The plurality of pixels is respectively associated with a plurality of respective pixel values based on the XR content. The plurality of pixels is respectively associated with a plurality of respective scaling factors defining an area in the display space based on the resolution function.

An image that is said to be in a display space has uniformly spaced regions (e.g., pixels or groups of pixels) that map to uniformly spaced regions (e.g., pixels or groups of pixels) of a display. An image that is said to be in a warped space has uniformly spaced regions (e.g., pixels or groups of pixels) that map to non-uniformly spaced regions (e.g., pixels or groups of pixels) in the display space. The relationship between uniformly spaced regions in the warped space to non-uniformly spaced regions in the display space is defined at least in part by the scaling factors. Thus, the plurality of respective scaling factors (like the resolution function) defines a mapping between the warped space and the display space.

In various implementations, the rendering module transmits the warped image including the plurality of pixel values in association with the plurality of respective scaling factors. Accordingly, the warped image and the scaling factors, rather than a foveated image which could be generated using this information, is propagated through the XR pipeline 200.

In particular, with respect to FIG. 2, in various implementations, the rendering module 210 generates a warped image and a plurality of respective scaling factors that are transmitted by the rendering module 210. At various stages in the XR pipeline 200, the warped image (or a processed version of the warped image) and the plurality of respective scaling factors are received (and used in processing the warped image) by the transport module 220 (and the compression module 222 and decompression module 226 thereof). At various stages in the XR pipeline 200, the warped image (or a processed version of the warped image) and the plurality of respective scaling factors are received (and used in processing the warped image) by the display module 230 (and the lens compensation module 232 and the panel compensation module 234 thereof).

In various implementations, the rendering module 210 generates the scaling factors based on the resolution function. For example, in some implementations, the scaling factors are generated based on the resolution function as described above with respect to FIGS. 5A-5C. In various implementations, generating the scaling factors includes determining the integral of the resolution function. In various implementations, generating the scaling factors includes determining the tangent of the inverse of the integral of the resolution function. In various implementations, generating the scaling factors includes, determining, for each of the respective locations uniformly spaced in a grid pattern in the warped space, the respective scaling factors based on the tangent of the inverse of the integral of the resolution function. Accordingly, for a plurality of locations uniformly spaced in the warped space, a plurality of locations non-uniformly spaced in the display space are represented by the scaling factors.

FIG. 8A illustrates an image representation of XR content 810 to be rendered in a display space. FIG. 8B illustrates a warped image 820 generated according to the method 700 of FIG. 7. In accordance with a resolution function, different parts of the XR content 810 corresponding to non-uniformly spaced regions (e.g., different amounts of area) in the display space are rendered into uniformly spaced regions (e.g., the same amount of area) in the warped image 820.

For example, the area at the center of the image representation of XR content 810 of FIG. 8A is represented by an area in the warped image 820 of FIG. 8B including K pixels (and K pixel values). Similarly, the area on the corner of the image representation of XR content 810 of FIG. 8A (a larger area than the area at the center of FIG. 8A) is also represented by an area in the warped image 820 of FIG. 8B including K pixels (and K pixel values).

As noted above, the rendering module 210 can perform static foveation or dynamic foveation. In various implementations, the rendering module 210 determines a foveation mode to apply for rendering XR content and performs static foveation or dynamic foveation according to the determined foveation mode. In a static foveation mode, the XR content is rendered independently of eye tracking data. In a no-foveation mode, the rendered image is characterized by fixed resolutions per display regions (e.g., a constant number of pixels per tile). In a dynamic foveation mode, the resolution of the rendered image depends on the gaze of a user.

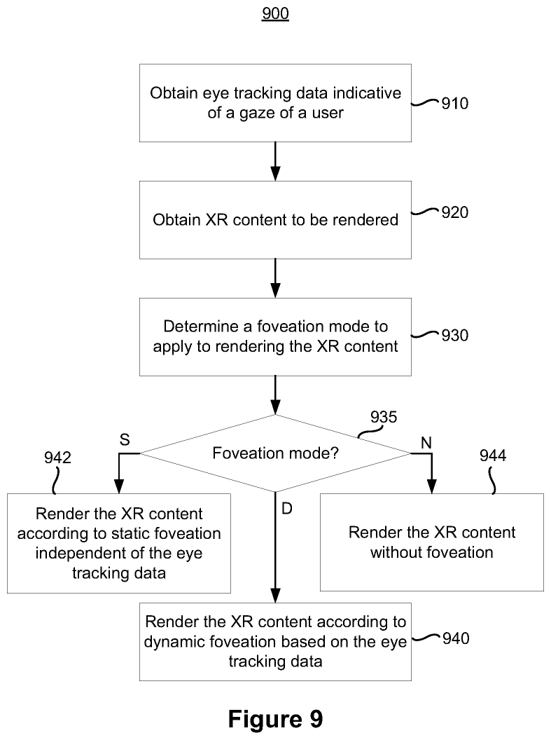

FIG. 9 is a flowchart representation of a method 900 of rendering an image in accordance with some implementations. In some implementations (and as detailed below as an example), the method 900 is performed by a rendering module, such as the rendering module 210 of FIG. 2. In various implementations, the method 900 is performed by an electronic device, such as the electronic device 120 of FIG. 1, or a portion thereof, such as the XR pipeline 200 of FIG. 2. In various implementations, the method 900 is performed by a device with one or more processors, non-transitory memory, and one or more XR displays. In some implementations, the method 900 is performed by processing logic, including hardware, firmware, software, or a combination thereof. In some implementations, the method 900 is performed by a processor executing instructions (e.g., code) stored in a non-transitory computer-readable medium (e.g., a memory).

The method 900 begins, in block 910, with the rendering module obtaining eye tracking data indicative of a gaze of a user (e.g., where a user is looking, such as gaze direction or a gaze point of a user). In various implementations, the eye tracking data includes at least one of a data indicative of a gaze angle of the user or data indicative of a gaze point of the user.

The method 900 continues, in block 920, with the rendering module obtaining XR content to be rendered. In various implementations, the XR content can include definitions of geometric shapes of virtual objects, colors and/or textures of virtual objects, images (such as a pass-through image of the scene), or other information describing content to be represented in a rendered image.

The method 900 continues, in block 930, with the rendering module determining a foveation mode to apply to rendering the XR content. In various implementations, the rendering module determines the foveation mode based on various factors. In some implementations, the rendering module determines the foveation mode based on a rendering processor characteristic. For example, in some implementations, the rendering module determines the foveation mode based on an available processing power, a processing speed, or a processor type of the rendering processor of the rendering module. When the rendering module has a large available processing power (due to a large processing capacity or low usage of the processing capacity), the rendering module selects a dynamic foveation mode and when the rendering module has a small available processing power (due to a small processing capacity or high usage of the processing capacity), the rendering module selects a static foveation mode or no-foveation mode. Referring to FIG. 1, when the rendering is performed by controller 110 (e.g., the rendering processor is at the controller), the rendering module selects a dynamic foveation mode and when the rendering is performed by the electronic device 120 (e.g., the rendering processor is at the electronic device 120), the rendering module 220 selects a static foveation mode or a no-foveation mode. In various implementations, switching between static and dynamic foveation modes occurs based on characteristics of the electronic device 120, such as the processing power of the electronic 120 relative to the processing power of the controller 110.

In some implementations, the rendering module selects a static foveation or a no-foveation mode when eye tracking performance (e.g., reliability) becomes sufficiently degraded. For example, in some implementations, static foveation mode or no-foveation mode is selected when eye tracking is lost. As another example, in some implementations, static foveation mode or no-foveation mode is selected when eye tracking performance breaches a threshold, such as when eye tracking accuracy falls too low (e.g., due to large gaps in eye tracking data) and/or latency related to eye tracking exceeds a value. In some implementations, the rendering module shifts focus to the center of the electronic device 120 and, using static foveation, gradually increases the fovea when diminishment of eye tracking performance during dynamic foveation (e.g., after a timeout, as indicated by a low prediction confidence) is suspected.

In various implementations, the rendering module selects a static foveation mode or no-foveation mode in order to account for other considerations. For example, in some implementations, the rendering module selects a static foveation mode or no-foveation mode where superior eye-tracking sensor performance is desirable. As another example, in some implementations, the rendering module selects a static foveation mode or no-foveation mode when the user wearing the electronic device 120 has a medical condition that prevents eye tracking or makes it sufficiently ineffective.

In various implementations, a static foveation mode or no-foveation mode is selected because it provides better performance of various aspects of the rendering imaging system. For example, in some implementations, static foveation mode or no-foveation mode provides better rate control. As another example, in some implementations, static foveation mode or no-foveation mode provides better concealment of mixed foveated and non-foveated regions (e.g., by making fainter the line demarcating the regions). As another example, in some implementations, a static foveation mode or no-foveation mode provides better display panel consumption bandwidth, by, for instance, using static grouped compensation data to maintain similar power and/or bandwidth. As yet another example, in some implementations, static foveation mode or no-foveation mode mitigates the risk of rendering undesirable visual aspects, such as flicker and/or artifacts (e.g., grouped rolling emission shear artifact).

The method 900 continues in decision block 935. In accordance with a determination that the foveation mode is a dynamic foveation mode, the method 900 continues (along path “D”), in block 940, with the rendering module rendering the XR content according to dynamic foveation based on the eye tracking data (e.g., as described above with respect to FIG. 7). In accordance with a determination that the foveation mode is a static foveation mode, the method 900 continues (along path “S”), in block 942, with the rendering module rendering the XR content according to static foveation independent of the eye tracking data (e.g., as described above with respect to FIG. 7). In accordance with a determination that the foveation mode is a no-foveation mode, the method 900 continues (along path “N”), in block 944, with the rendering module rendering the XR content without foveation.

In various implementations, the method 900 returns to block 920 (not illustrated) where additional XR content is received. In various implementations, the rendering module renders different XR content with different foveation modes depending on changing circumstances. While shown in a particular order, it should be appreciated that blocks of method 900 can be performed in different orders or at the same time. For example, eye tracking data can be obtained (e.g., as in block 910) throughout the performance of method 900 and that blocks relying on that data can use any of the previously obtained (e.g., most recently obtained) eye tracking data or variants thereof (e.g., windowed average or the like).

In addition to, or as an alternative to, switching between foveation modes, in various implementations, the rendering module 210 generates the resolution function base on various conditions of the XR pipeline 200, such as eye tracking metadata characterizing the eye tracking performed by the eye tracker 260 or resolution constraints characterizing a potential throughput of the XR pipeline 200.

In various implementations, the rendering module 210 generates the resolution function based on eye tracking metadata. In various implementations, the rendering module 210 generates the resolution function based on eye tracking metadata indicative of a confidence of the eye tracking data. For example, in various implementations, the eye tracking metadata provides a measurement of a belief that the eye tracking data correctly indicates the gaze of the user. In various implementations, the eye tracking metadata indicative of the confidence of the eye tracking data includes data indicative of an accuracy of the eye tracking data. In various implementations, the eye tracking metadata indicative of the confidence of the eye tracking data includes data indicative of a latency of the eye tracking metadata.

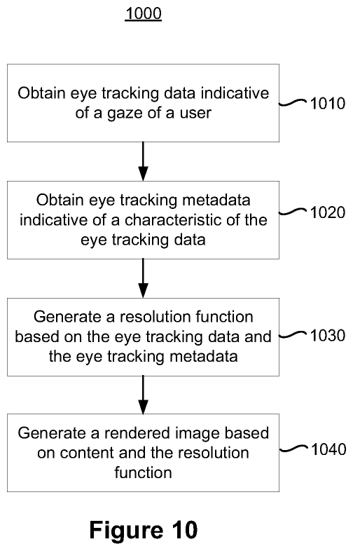

FIG. 10 is a flowchart representation of a method 1000 of rendering an image in accordance with some implementations. In some implementations (and as detailed below as an example), the method 1000 is performed by a rendering module, such as the rendering module 210 of FIG. 2. In various implementations, the method 1000 is performed by an electronic device, such as the electronic device 120 of FIG. 1, or a portion thereof, such as the XR pipeline 200 of FIG. 2. In various implementations, the method 1000 is performed by a device with one or more processors, non-transitory memory, and one or more XR displays. In some implementations, the method 1000 is performed by processing logic, including hardware, firmware, software, or a combination thereof. In some implementations, the method 1000 is performed by a processor executing instructions (e.g., code) stored in a non-transitory computer-readable medium (e.g., a memory).

The method 1000 begins, at block 1010, with the rendering module obtaining eye tracking data indicative of a gaze of a user (e.g., where a user is looking, such as gaze direction or a gaze point of a user). In various implementations, the eye tracking data includes at least one of a data indicative of a gaze angle of the user or data indicative of a gaze point of the user.

The method 1000 continues, at block 1020, with the rendering module obtaining eye tracking metadata indicative of a characteristic of the eye tracking data. In various implementations, the eye tracking metadata is obtained in association with the corresponding eye tracking data. In various implementations, the eye tracking data and the associated eye tracking metadata are received from an eye tracker, such as the eye tracker 260 of FIG. 2.

In various implementations, the eye tracking metadata includes data indicative of a confidence of the eye tracking data. For example, in various implementations, the eye tracking metadata provides a measurement of a belief that the eye tracking data correctly indicates the gaze of the user.

In various implementations, the data indicative of the confidence of the eye tracking data includes data indicative of an accuracy of the eye tracking data. In various implementations, the rendering module generates the data indicative of the accuracy of the eye tracking data based on a series of recently captured images of the eye of the user, recent measurements of the gaze of the user, user biometrics, and/or other obtained data.

In various implementations, the data indicative of the confidence of the eye tracking data includes data indicative of a latency of the eye tracking data (e.g., a difference between the time the eye tracking data is generated and the time the eye tracking data is received by the rendering module). In various implementations, the rendering module generates the data indicative of the latency of the eye tracking data based on timestamps of the eye tracking data. In various implementations, the confidence of the eye tracking data is higher when the latency is less than when the latency is more.

In various implementations, the eye tracking data includes data indicative of a prediction of the gaze of the user, and the data indicative of a confidence of the eye tracking data includes data indicative of a confidence of the prediction. In various implementations, the data indicative of a prediction of the gaze of the user is based on past measurements of the gaze of the user based on past captured images. In various implementations, the prediction of the gaze of the user is based on classifying past motion of the gaze of the user as a continuous fixation, smooth pursuit, or saccade. In various implementations, the confidence of the prediction is based on this classification. In particular, in various implementations, the confidence of the prediction is higher when past motion is classified as a continuous fixation or smooth pursuit than when the past motion is classified as a saccade.

In various implementations, the eye tracking metadata includes data indicative of one or more biometrics of the user, and, in particular, biometrics which affect the eye tracking metadata or its confidence. In particular, in various implementations, the biometrics of the user include one or more of eye anatomy, ethnicity/physiognomy, eye color, age, visual aids (e.g., corrective lenses), make-up (e.g., eyeliner or mascara), medical condition, historic gaze variation, input preferences or calibration, headset position/orientation, pupil dilation/center-shift, and/or eyelid position.

In various implementations, the eye tracking metadata includes data indicative of one or more environmental conditions of an environment of the user in which the eye tracking data was generated. In particular, in various implementations, the environmental conditions include one or more of vibration, ambient temperature, IR directional light, or IR light intensity.

The method 1000 continues, at block 1030, with the rendering module generating a resolution function based on the eye tracking data and the eye tracking metadata. In various implementations, the rendering module generates the resolution function with a peak maximum based on the eye tracking data (e.g., the resolution is highest where the user is looking). In various implementations, the rendering module generates the resolution function with a peak width based on the eye tracking metadata (e.g., with a wider peak when the eye tracking metadata indicates less confidence in the correctness of the eye tracking data).

The method 1000 continues, at block 1040, with the rendering module generating a rendered image based on content (e.g., XR content) and the resolution function (e.g., as described above with respect to FIG. 7). In various implementations, the rendered image is a foveated image, such as an image having lower resolution outside the user's fovea. In various implementations, the rendered image is a warped image, such as an image transformed into a non-uniform space as compared to the content.

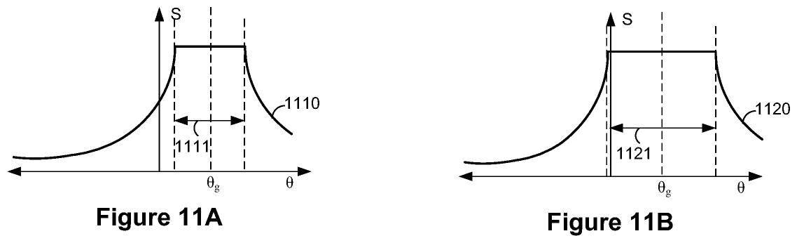

FIG. 11A illustrates a resolution function 1110 that may be used by the rendering module when performing dynamic foveation, when the eye tracking data indicates that the user is looking at an angle (9g) away from the center of the display panel, and when the eye tracking metadata indicates a first confidence resulting in a first peak width 1111. FIG. 11B illustrates a resolution function 1120 that may be used by the rendering module when performing dynamic foveation, when the eye tracking data indicates that the user is looking at the angle (9g) away from the center of the display panel, and when the eye tracking metadata indicates a second confidence, less than the first confidence, resulting in a second peak width 1121 greater than the first peak width 1111.

In various implementations, the rendering module detects loss of an eye tracking stream including the eye tracking metadata and the eye tracking data. In response, the rendering module generates a second resolution function based on detecting the loss of the eye tracking stream and generates a rendered image based on the content and the second resolution function.

In various implementations, detecting the loss of the eye tracking stream includes determining that the gaze of the user was static at a time of the loss of the eye tracking stream. Accordingly, in various implementations, generating the second resolution function includes generating the second resolution function with a peak maximum at a same location as a peak maximum of the resolution function and with a peak width greater than a peak width of the resolution function. Thus, in various implementations, in response to detecting the loss of an eye tracking stream, the resolution function stays at the same location, but the size of the fovea increases.

In various implementations, detecting the loss of the eye tracking stream includes determining that the gaze of the user was moving at a time of the loss of the eye tracking stream. Accordingly, in various implementations, generating the second resolution function includes generating the second resolution function with a peak maximum at a location displaced toward the center as compared to a peak maximum of the resolution function, and with a peak width greater than a peak width of the resolution function. Thus, in various implementations, in response to detecting the loss of an eye tracking stream, the resolution function moves to the center of the display panel and the size of the fovea increases.

In various implementations, detecting the loss of the eye tracking stream includes determining that the gaze of the user was moving in a direction at a time of the loss of the eye tracking stream. Accordingly, in various implementations, generating the second resolution function includes generating the second resolution function with a peak maximum at a location displaced in the direction as compared to a peak maximum of the resolution function, and with a peak width greater than a peak width of the resolution function. Thus, in various implementations, in response to detecting the loss of an eye tracking stream, the resolution function moves to a predicted location and the size of the fovea increases.

In various implementations, the rendering module 210 generates the resolution function based on a resolution constraint. In various implementations, the rendering module 210 generates the resolution function based on a resolution constraint indicative of a number of pixels the XR pipeline 200 can throughput in a particular time period, such as a frame period. In various implementations, the rendering module 210 generates the resolution function with a default set of parameters unless a resolution constraint is detected.

In various circumstances, using the same set of default parameters for different images may result in the rendering module 210 rendering the images with a different number of pixels. In various implementations, the number of pixels in a rendered image is proportional to the integral of the resolution function over the field-of-view. Thus, a summation value is defined as the area under the resolution function over the field-of-view. As an example, using two resolution functions with the same peak height and peak width but different peak height locations (e.g., the resolution functions of FIGS. 6A and 6B), the rendering module 210 renders two images with two different summation values.

In response to detecting the resolution constraint, the rendering module 210 generates the resolution function with a modified set of parameters so that the resolution function meets the resolution constraint. In various implementations, the modified set of parameters includes a peak height and a peak width. In various implementations, the modified set of parameters includes a resolution function maximum and a resolution function minimum (or asymptote). In various implementations, the rendering module 210 determines the modified set of parameters by decreasing at least one of the default set of parameters such that the resolution function has a summation value that meets the resolution constraint.

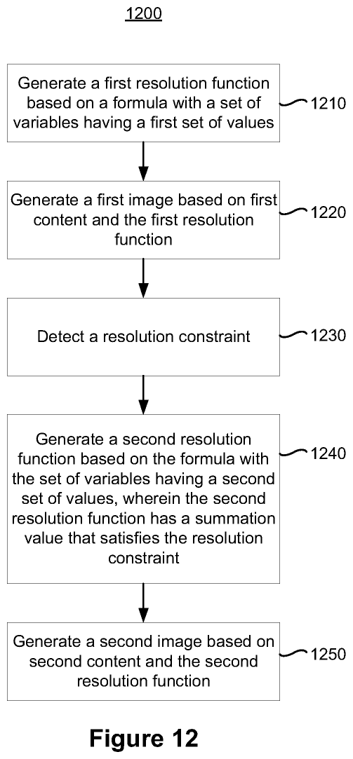

FIG. 12 is a flowchart representation of a method 1200 of generating an image in accordance with some implementations. In some implementations (and as detailed below as an example), the method 1200 is performed by a rendering module, such as the rendering module 210 of FIG. 2. In various implementations, the method 1200 is performed by an electronic device, such as the electronic device 120 of FIG. 1, or a portion thereof, such as the XR pipeline 200 of FIG. 2. In various implementations, the method 1200 is performed by a device with one or more processors, non-transitory memory, and one or more XR displays. In some implementations, the method 1200 is performed by processing logic, including hardware, firmware, software, or a combination thereof. In some implementations, the method 1200 is performed by a processor executing instructions (e.g., code) stored in a non-transitory computer-readable medium (e.g., a memory).

The method 1200 begins, at block 1210, with the rendering module generating a first resolution function based on a formula with a set of variables having a first set of values. For example, in various implementations, the first set of values is a default set of values. In various implementations, the formula is (in a first dimension):

$$S ( θ ) = \{ \begin{matrix}{S}_{max} & for \vert θ - {θ}_{ℊ} \vert < {θ}_{f} \\ {S}_{min} + \frac{{S}_{max} - {S}_{min}}{1 + w ( \vert θ - {θ}_{ℊ} - {θ}_{f} \vert )} & for \vert θ - {θ}_{ℊ} \vert \geq {θ}_{f}\end{matrix} .$$

Thus, in various implementations, the set of variables includes a maximum (Sₘₐₓ), an asymptote (Sₘᵢₙ), a first width (θ_{f}), and a second width (w). In various implementations, the set of variables includes at least one of a maximum, a minimum, an asymptote, or a width.

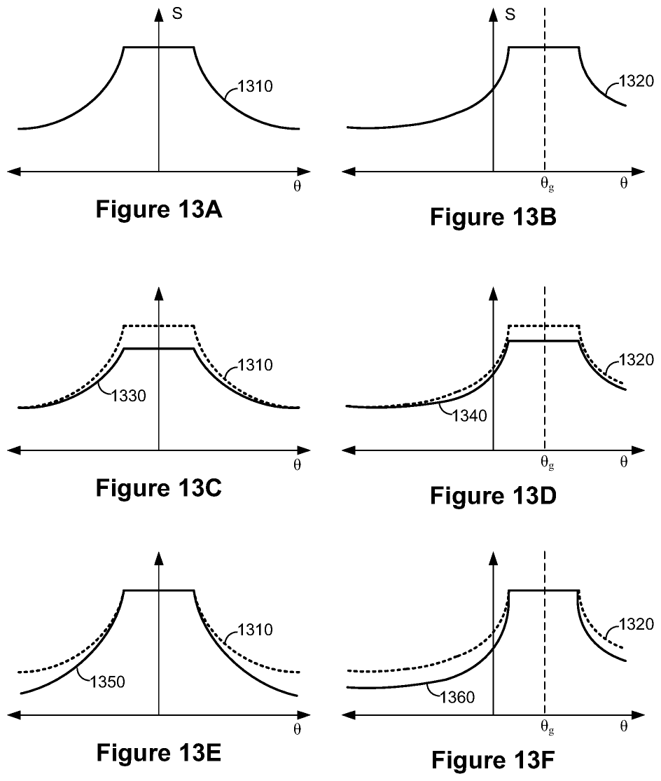

FIG. 13A illustrates a first resolution function 1310 resulting from evaluating the formula with a first set of values and a gaze angle of zero. FIG. 13B illustrates a second resolution function 1320 resulting from evaluating the formula with the first set of values and a non-zero gaze angle of θ_{g}. The summation value of the second resolution function 1320 is slightly less than the summation value of the first resolution function 1310 as the second resolution function 1320 includes a far periphery region (on the left) that is not present in the first resolution function 1310.

The method 1200 continues, at block 1220, with the rendering module generating a first image based on first content (e.g., first XR content) and the first resolution function (e.g., as described above with respect to FIG. 7). In various implementations, the first image is a foveated image, such as an image having lower resolution outside the user's fovea. In various implementations, the first image is a warped image, such as an image transformed into a non-uniform space as compared to the content.

The method 1200 continues, at block 1230, with the rendering module detecting a resolution constraint. In various implementations, the resolution constraint indicates a number of pixels. In various implementations, the resolution constraint indicates a summation value. In various implementations, the resolution constraint is detected based on a user input. For example, in various implementations, a user activates a low-power mode and, in response, a resolution constraint is generated and/or detected by the rendering module. In various implementations, the resolution constraint is detected based on an amount of available processing power. For example, when the rendering module has a small available processing power (due to a small processing capacity or high usage of the processing capacity), the rendering module may generate and/or detect a resolution constraint. As another example, when a thermal event occurs (e.g., when processing to compute additional pixel values would cause a processor to overheat), the rendering module may generate and/or detect a resolution constraint. In various implementations, the resolution constraint is generated based on a bandwidth of a communications channel. For example, in response to a decrease in signal-to-noise ratio of a communications channel, the rendering module may generate and/or detect a resolution constraint. In various implementations, the rendering module receives the resolution constraint from a transport module of an XR pipeline including the rendering module.

The method 1200 continues, in block 1240, with the rendering module generating a second resolution function based on the formula with the set of variables having a second set of values, wherein the second resolution function has a summation value that satisfies the resolution constraint.

In various implementations, generating the second resolution function includes determining the second set of values by decreasing at least one of the first set of values. In various implementations, determining an amount to decrease the at least one of the first set of values can be performed iteratively until the resulting resolution function satisfies the resolution constraint. For example, in various implementations, determining the second set of values includes decreasing a maximum of the function from a first value to a second value less than the first value.

FIG. 13C illustrates a third resolution function 1330 resulting from evaluating the formula with a second set of values and a gaze angle of zero. The second set of values is determined from the first set of values by decreasing the maximum from a first value to a second value. FIG. 13D illustrates a fourth resolution function 1340 resulting from evaluating the formula with a third set of values and a non-zero gaze angle of θ_{g}. The third set of values is determined from the first set of values by decreasing the maximum from the first value to a third value. The summation value of the third resolution function 1330 and the fourth resolution function 1340 each satisfy the same resolution constraint. In various implementations, the maximum of the fourth resolution function 1340 (e.g., the third value) is greater than the maximum of the third resolution function (e.g., the second value).

As another example, in various implementations, determining the second set of values includes decreasing an asymptote of the function from a first value to a second value less than the first value.

FIG. 13E illustrates a fifth resolution function 1350 resulting from evaluating the formula with a fourth set of values and a gaze angle of zero. The fourth set of values is determined from the first set of values by decreasing the asymptote from a first value to a second value. FIG. 13F illustrates a fifth resolution function 1360 resulting from evaluating the formula with a fifth set of values and a non-zero gaze angle of 9g. The fifth set of values is determined from the first set of values by decreasing the asymptote from the first value to a third value. The summation value of the fifth resolution function 1350 and the sixth resolution function 1360 each satisfy the same resolution constraint. In various implementations, the asymptote of the sixth resolution function 1360 (e.g., the third value) is greater than the asymptote of the fifth resolution function (e.g., the second value).

In various implementations, determining the second set of values by decreasing at least one of the first set of values includes selecting the at least one of the first set of values from the first set of values. For example, in various implementations, the rendering module selects a maximum to decrease from a first value to a second value. As another example, the rendering module selects an asymptote to decrease from a first value to a second value. In various implementations, selecting the at least one of the first set of values includes determining a relative amount of decrease for two or more of the first set of values. For example, in various implementations, the rendering module determines to decrease an asymptote more than it decreases a maximum.

In various implementations, selecting the at least one of the first set of values is based on the second content. For example, in various implementations, if the second content includes moving objects, the amount that the rendering module decreases the maximum as compared to the asymptote is more than if the second content did not include moving objects. Thus, in various implementations, selecting the at least one of the first set of values is based on a dynamicity of the second content. In various implementations, the second content includes a pass-through image of a physical environment and the dynamicity of the second content is based on motion of the device.

As another example, if the second content has a particular resolution (particularly at a location at which the user is looking), the amount that the rendering module decreases the maximum is based on that particular resolution. For example, in various implementations, the user is watching video of a particular resolution displayed by a video application and the rendering module decreases the amount of the maximum based on the particular resolution. Thus, in various implementations, selecting the at least one of the first set of values is based on a resolution of the second content (e.g., at a gaze point of the user). Accordingly, in various implementations, selecting the at least one of the first set of values is based on eye tracking data indicative of a gaze of the user. As another example, in various implementations, if the gaze of the user is moving, the rendering module decreases the amount of the maximum as compared to the asymptote more than if the gaze of the user is static.

In various implementations, selecting the at least one of the first set of values is based on a user preference or an application preference. For example, in various implementations, if a user has selected a low-resolution mode, the rendering module decreases the amount of the maximum as compared to the asymptote more than if the user has selected a high-resolution mode. As another example, an application specifies which value to reduce in response to a resolution constraint. For example, a gaming application may specify reduction of a maximum (to maintain at least a minimum resolution over the field-of-view), whereas as an ebook reader application may specify reduction of value (or combination of values) affecting far periphery (to maintain high resolution where the user is reading and is about to read).

In various implementations, generating the second resolution function is further based on eye tracking data indicative of a gaze of a user. For example, in various implementations, the rendering module performs dynamic foveation and a location of the peak height is based on the gaze of the user. In various implementations, generating the second resolution function is further based on eye tracking metadata indicative of a characteristic of the eye tracking data (e.g., as described above with respect to FIG. 10).

The method 1200 continues, at block 1250, with the rendering module generating a second image based on second content (e.g., second XR content) and the second resolution function (e.g., as described above with respect to FIG. 7). In various implementations, the second image is a foveated image, such as an image having lower resolution outside the user's fovea. In various implementations, the second image is a warped image, such as an image transformed into a non-uniform space as compared to the content.

In various implementations, the rendering module transitions between rendering images with the first resolution function and the second resolution function to reduce a user's perception of the transition. For example, in various implementations, the rendering module transitions during a blink or a saccade of the user. Thus, in various implementations, generating the second image is performed during a blink or a saccade of a user. As another example, the rendering module transitions over a plurality of frame periods. Thus, in various implementations, generating the second image is performed after a plurality of frame periods and the method 1200 further comprises decreasing, at each of the plurality of frame periods, at least one of the first set of values.

Although it may be beneficial to apply foveation as early as possible in the pipeline (e.g., when rendering), it may also be beneficial to apply foveation at any stage of the pipeline (e.g., during compression before transmission or after transmission before display). Accordingly, in various implementations, generating the second image includes rendering the second image including the second content based on the second resolution function. In various implementations, generating the second image includes compressing an image including the second content based on the second resolution function.

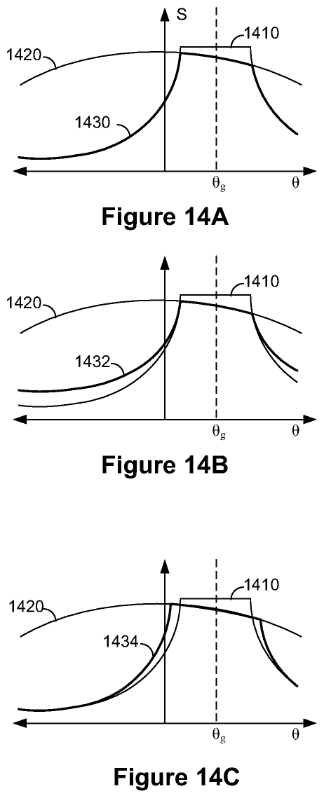

FIG. 14A illustrates an eyepiece resolution function 1420, E(θ), that varies as a function of angle. The eyepiece resolution function 1420 has a maximum at the center of the eyepiece 242 and falls off towards the edges. In various implementations, the eyepiece resolution function 1420 includes a portion of a circle, ellipse, parabola, or hyperbola.

FIG. 14A also illustrates an unconstrained resolution function 1410, Sᵤ(θ), that has a peak centered at a gaze angle (tθ_{g}). Around the peak, the unconstrained resolution function 1410 is greater than the eyepiece resolution function 1420. Thus, if the rendering module 210 were to render an image having the resolution indicated by the unconstrained resolution function 1410, details at those angles would be stripped by the eyepiece 242. Accordingly, in order to avoid the computational expense and delay in rendering those details, in various implementations, the rendering module 210 generates a capped resolution function 1430 (in bold), S_{c}(θ), equal to the lesser of the eyepiece resolution function 1410 and the unconstrained resolution function. Thus, S_{c}(θ)=min (E(θ),Sᵤ(θ)).

In various implementations, the rendering module 210 generates a resolution function with a summation value that satisfies a resolution constraint. The summation value of the capped resolution function 1430 is less than the summation value of the unconstrained resolution function 1410. In order to generate a resolution function with a greater summation value while still satisfying the resolution constraint, the rendering module increases values of the capped resolution function 1430 that were not decreased as compared to the unconstrained resolution function 1410. For example, FIG. 14B illustrates a first constrained resolution function 1432 in which the asymptote of the resolution function is increased as compared to the asymptote of the capped resolution function 1430. As another example, FIG. 14C illustrates a second constrained resolution function 1434 in which the peak width of the resolution function is increased as compared to the peak width of the capped resolution function 1430.

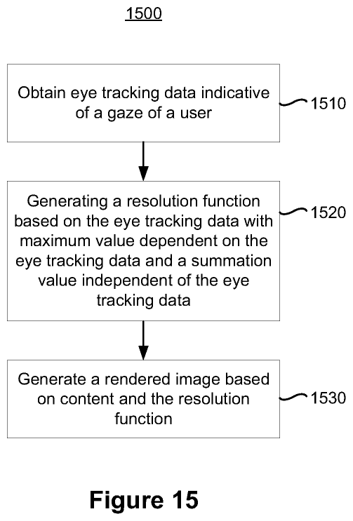

FIG. 15 is a flowchart representation of a method 1500 of rendering an image in accordance with some implementations. In some implementations (and as detailed below as an example), the method 1500 is performed by a rendering module, such as the rendering module 210 of FIG. 2. In various implementations, the method 1500 is performed by an electronic device, such as the electronic device 120 of FIG. 1, or a portion thereof, such as the XR pipeline 200 of FIG. 2. In various implementations, the method 1500 is performed by a device with one or more processors, non-transitory memory, and one or more XR displays. In some implementations, the method 1500 is performed by processing logic, including hardware, firmware, software, or a combination thereof. In some implementations, the method 1500 is performed by a processor executing instructions (e.g., code) stored in a non-transitory computer-readable medium (e.g., a memory).

The method 1500 begins, in block 1510, with the rendering module obtaining eye tracking data indicative of a gaze of a user (e.g., where the user is looking, such as gaze direction and/or gaze point of the user). In various implementations, the rendering module receives data indicative of performance characteristics of an eyepiece at least at the gaze of the user. In various implementations, performance characteristics of the eyepiece at the gaze of the user can be determined from the eye tracking data.

The method 1500 continues, in block 1520, with the rendering module generating a resolution function based on the eye tracking data, the resolution function having a maximum value dependent on the eye tracking data and a summation value independent of the eye tracking data. In various implementations, the summation value satisfies a resolution constraint.

In various implementations, generating the resolution function includes generating an unconstrained resolution function based on the eye tracking data (such as the unconstrained resolution function 1410 of FIG. 14A); determining the maximum value (of the resolution function after constraining) based on the eye tracking data (and, optionally, an eyepiece resolution function such as the eyepiece resolution function 1420 of FIG. 14A); decreasing values of the unconstrained resolution function above the maximum value to the maximum value in order to generate a capped resolution function (such as the capped resolution function 1430 of FIG. 14A); and increasing non-decreased values of the capped resolution function in order to generate the resolution function. In various implementations, increasing the non-decreased values of the capped resolution function includes increasing an asymptote of the capped resolution function. In various implementations, increasing the non-decreased values of the capped resolution function includes increasing a peak width of the capped resolution function, such as increasing the size of the fovea.

In various implementations, the maximum value is based on a mapping between the gaze of the user and lens performance characteristics. In some implementations, the lens performance characteristics are represented by an eyepiece resolution function or a modulation transfer function (MTF). In some implementations, the lens performance characteristics are determined by surface lens modeling.

In various implementations, the maximum value is determined as a function of gaze direction (because the eyepiece resolution function varies as a function of gaze direction). In various implementations, the maximum value is based on changes in the gaze of the user, such as gaze motion (e.g., changing gaze location). For example, in some implementations, the maximum value of the resolution function is decreased when the user is looking around (because resolution perception decreases during eye motion). As another example, in some implementations, when the user blinks, the maximum value of the resolution function is decreased (because resolution perception [and eye tracking confidence] decreases when the user blinks).

In various implementations, the maximum value is affected by the lens performance characteristics. For example, in some implementations, the maximum value is decreased when the lens performance characteristics indicate that the lens cannot support a higher resolution. In some implementations, the lens performance characteristics include a distortion introduced by a lens.

The method 1500 continued in block 1530, with the rendering module generating a rendered image based on content (e.g., XR content) and the resolution function (e.g., as described above with respect to FIG. 7). In various implementations, the rendered image is a foveated image, such as an image having lower resolution outside the user's fovea. In various implementations, the rendered image is a warped image, such as an image transformed into a non-uniform space as compared to the XR content.

FIG. 16 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 1602 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 1606, one or more communication interfaces 1608 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 1610, a memory 1620, and one or more communication buses 1604 for interconnecting these and various other components.

In some implementations, the one or more communication buses 1604 include circuitry that interconnects and controls communications between system components. In some implementations, the one or more I/O devices 1606 include at least one of a keyboard, a mouse, a touchpad, a joystick, one or more microphones, one or more speakers, one or more image sensors, one or more displays, and/or the like.

The memory 1620 includes high-speed random-access memory, such as dynamic random-access memory (DRAM), static random-access memory (SRAM), double-data-rate random-access memory (DDR RAM), or other random-access solid-state memory devices. In some implementations, the memory 1620 includes non-volatile memory, such as one or more magnetic disk storage devices, optical disk storage devices, flash memory devices, or other non-volatile solid-state storage devices. The memory 1620 optionally includes one or more storage devices remotely located from the one or more processing units 1602. The memory 1620 comprises a non-transitory computer readable storage medium. In some implementations, the memory 1620 or the non-transitory computer readable storage medium of the memory 1620 stores the following programs, modules and data structures, or a subset thereof including an optional operating system 1630 and an XR experience module 1640.

The operating system 1630 includes procedures for handling various basic system services and for performing hardware dependent tasks. In some implementations, the XR experience module 1640 is configured to manage and coordinate one or more XR experiences for one or more users (e.g., a single XR experience for one or more users, or multiple XR experiences for respective groups of one or more users). To that end, in various implementations, the XR experience module 1640 includes a data obtaining unit 1642, a tracking unit 1644, a coordination unit 1646, and a data transmitting unit 1648.

In some implementations, the data obtaining unit 1642 is configured to obtain data (e.g., presentation data, interaction data, sensor data, location data, etc.) from at least the electronic device 120 of FIG. 1. To that end, in various implementations, the data obtaining unit 1642 includes instructions and/or logic therefor, and heuristics and metadata therefor.

In some implementations, the tracking unit 1644 is configured to map the physical environment 105 and to track the position/location of at least the electronic device 120 with respect to the physical environment 105 of FIG. 1. To that end, in various implementations, the tracking unit 1644 includes instructions and/or logic therefor, and heuristics and metadata therefor.

In some implementations, the coordination unit 1646 is configured to manage and coordinate the XR experience presented to the user by the electronic device 120. To that end, in various implementations, the coordination unit 1646 includes instructions and/or logic therefor, and heuristics and metadata therefor.

In some implementations, the data transmitting unit 1648 is configured to transmit data (e.g., presentation data, location data, etc.) to at least the electronic device 120. To that end, in various implementations, the data transmitting unit 1648 includes instructions and/or logic therefor, and heuristics and metadata therefor.

Although the data obtaining unit 1642, the tracking unit 1644, the coordination unit 1646, and the data transmitting unit 1648 are shown as residing on a single device (e.g., the controller 110), it should be understood that in other implementations, any combination of the data obtaining unit 1642, the tracking unit 1644, the coordination unit 1646, and the data transmitting unit 1648 may be located in separate computing devices.

Moreover, FIG. 16 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 16 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 17 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 1702 (e.g., microprocessors, ASICs, FPGAs, GPUs, CPUs, processing cores, and/or the like), one or more input/output (I/O) devices and sensors 1706, one or more communication interfaces 1708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 1710, one or more XR displays 1712, one or more optional interior- and/or exterior-facing image sensors 1714, a memory 1720, and one or more communication buses 1704 for interconnecting these and various other components.

In some implementations, the one or more communication buses 1704 include circuitry that interconnects and controls communications between system components. In some implementations, the one or more I/O devices and sensors 1706 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 1712 are configured to provide the XR experience to the user. In some implementations, the one or more XR displays 1712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 1712 correspond to diffractive, reflective, polarized, holographic, etc. waveguide displays. For example, the electronic device 120 includes a single XR display. In another example, the electronic device includes an XR display for each eye of the user. In some implementations, the one or more XR displays 1712 are capable of presenting MR and VR content.

In some implementations, the one or more image sensors 1714 are configured to obtain image data that corresponds to at least a portion of the face of the user that includes the eyes of the user (any may be referred to as an eye-tracking camera). In some implementations, the one or more image sensors 1714 are configured to be forward-facing so as to obtain image data that corresponds to the physical environment as would be viewed by the user if the electronic device 120 was not present (and may be referred to as a scene camera). The one or more optional image sensors 1714 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 1720 includes high-speed random-access memory, such as DRAM, SRAM, DDR RAM, or other random-access solid-state memory devices. In some implementations, the memory 1720 includes non-volatile memory, such as one or more magnetic disk storage devices, optical disk storage devices, flash memory devices, or other non-volatile solid-state storage devices. The memory 1720 optionally includes one or more storage devices remotely located from the one or more processing units 1702. The memory 1720 comprises a non-transitory computer readable storage medium. In some implementations, the memory 1720 or the non-transitory computer readable storage medium of the memory 1720 stores the following programs, modules and data structures, or a subset thereof including an optional operating system 1730 and an XR presentation module 1740.

The operating system 1730 includes procedures for handling various basic system services and for performing hardware dependent tasks. In some implementations, the XR presentation module 1740 is configured to present XR content to the user via the one or more XR displays 1712. To that end, in various implementations, the XR presentation module 1740 includes a data obtaining unit 1742, a resolution function generating unit 1744, an XR presenting unit 1746, and a data transmitting unit 1748.

In some implementations, the data obtaining unit 1742 is configured to obtain data (e.g., presentation data, interaction data, sensor data, location data, etc.) from at least the controller 110 of FIG. 1. To that end, in various implementations, the data obtaining unit 1742 includes instructions and/or logic therefor, and heuristics and metadata therefor.

In some implementations, the resolution function generating unit 1744 is configured to generate a resolution function that satisfies a resolution constraint. To that end, in various implementations, the resolution function generating unit 1744 includes instructions and/or logic therefor, and heuristics and metadata therefor.

In some implementations, the XR presenting unit 1746 is configured to display the transformed image via the one or more XR displays 1712. To that end, in various implementations, the XR presenting unit 1746 includes instructions and/or logic therefor, and heuristics and metadata therefor.

In some implementations, the data transmitting unit 1748 is configured to transmit data (e.g., presentation data, location data, etc.) to at least the controller 110. In some implementations, the data transmitting unit 1748 is configured to transmit authentication credentials to the electronic device. To that end, in various implementations, the data transmitting unit 1748 includes instructions and/or logic therefor, and heuristics and metadata therefor.

Although the data obtaining unit 1742, the resolution function generating unit 1744, the XR presenting unit 1746, and the data transmitting unit 1748 are shown as residing on a single device (e.g., the electronic device 120), it should be understood that in other implementations, any combination of the data obtaining unit 1742, the resolution function generating unit 1744, the XR presenting unit 1746, and the data transmitting unit 1748 may be located in separate computing devices.

Moreover, FIG. 17 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 17 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device including one or more processors and non-transitory memory:
generating a first resolution function based on a formula with a set of variables having a first set of values;
generating a first image based on first content and the first resolution function;
detecting a resolution constraint;
generating a second resolution function based on the formula with the set of variables having a second set of values, wherein the second resolution function has a summation value that satisfies the resolution constraint; and
generating a second image based on second content and the second resolution function.

2. The method of claim 1, wherein the set of variables includes at least one of a maximum, a minimum, an asymptote, or a width.

3. The method of claim 1, wherein the resolution constraint indicates a number of pixels and the summation value satisfies the resolution constraint when the second image has less than the number of pixels.

4. The method of claim 1, wherein the resolution constraint is generated based on an amount of available processing power.

5. The method of claim 1, wherein the resolution constraint is generated based on a bandwidth of a communications channel.

6. The method of claim 1, wherein generating the second resolution function includes determining the second set of values by decreasing at least one of the first set of values.

7. The method of claim 6, wherein determining the second set of values by decreasing at least one of the first set of values includes selecting the at least one of the first set of values from the first set of values.

8. The method of claim 7, wherein selecting the at least one of the first set of values is based on the second content.

9. The method of claim 7, wherein selecting the at least one of the first set of values is based on eye tracking data indicative of a gaze of a user.

10. The method of claim 1, wherein generating the second image is performed during a blink or a saccade of a user.

11. The method of claim 1, wherein generating the second image is performed after a plurality of frame periods, the method further comprising decreasing, at each of the plurality of frame periods, at least one of the first set of values.

12. A device comprising:
a non-transitory memory; and
one or more processors to:
generate a first resolution function based on a formula with a set of variables having a first set of values;
generate a first image based on first content and the first resolution function;
detect a resolution constraint;
generate a second resolution function based on the formula with the set of variables having a second set of values, wherein the second resolution function has a summation value that satisfies the resolution constraint; and
generate a second image based on second content and the second resolution function.

13. The device of claim 12, wherein the set of variables includes at least one of a maximum, a minimum, an asymptote, or a width.

14. The device of claim 12, wherein the resolution constraint indicates a number of pixels and the summation value satisfies the resolution constraint when the second image has less than the number of pixels.

15. The device of claim 12, wherein the resolution constraint is generated based on an amount of available processing power.

16. The device of claim 12, wherein the one or more processors are to generate the second resolution function by determining the second set of values by decreasing at least one of the first set of values.

17. The device of claim 12, wherein the one or more processors are to generate the second image is performed during a blink or a saccade of a user.

18. The device of claim 12, wherein the one or more processors are to generate the second image after a plurality of frame periods and are further to decrease, at each of the plurality of frame periods, at least one of the first set of values.

19. A non-transitory computer-readable memory having instructions encoded thereon which, when executed by one or more processors of a device, cause the device to:
generate a first resolution function based on a formula with a set of variables having a first set of values;
generate a first image based on first content and the first resolution function;
detect a resolution constraint;
generate a second resolution function based on the formula with the set of variables having a second set of values, wherein the second resolution function has a summation value that satisfies the resolution constraint; and
generate a second image based on second content and the second resolution function.

20. The non-transitory computer-readable memory of claim 19, wherein the resolution constraint is generated based on an amount of available processing power.
